(19) United States
(12) Patent Application Publication
(10) Pub. No.: US 2013/0157601 A1
(43) Pub. Date: Jun. 20, 2013

(54) POLARIZATION CONTROL DEVICE, INTEGRATED CIRCUIT AND METHOD FOR COMPENSATING PHASE MISMATCH

(71) Applicants: Conor O'Keeffee, Douglas (IE); Michael O'Brien, Youghal (IE)

(72) Inventors: Conor O'Keeffee, Douglas (IE); Michael O'Brien, Youghal (IE)

(73) Assignee: SOCOWAVE TECHNOLOGIES LIMITED, Dublin (IE)

(21) Appl. No.: 13/818,074

(22) PCT Filed: Aug. 19, 2011
(86) PCT No.: PCT/EP11/64271

§ 371 Date: Feb. 20, 2013

(30) Foreign Application Priority Data
Aug. 20, 2010 (GB) 1013970.7

(51) Int. Cl. H04W 24/02

(52) U.S. Cl. CPC H04W 24/02
USPC 455/226.1

(57) ABSTRACT

A polarization control device (360) for compensating phase mismatch, wherein the polarization control device (360) is operably coupleable via at least two radio frequency (RF) feed paths to an antenna arrangement (219) that comprises at least two orthogonally polarized antenna elements. The polarization control device (360) comprises or is operably coupleable to at least one variable phase shifter (420) located on at least one RF feed path. The polarization control device (360) further comprises a processing module (490) configured to: receive and process at least one first RF signal; determine a relative phase mismatch between the at least two RF feed paths to the antenna arrangement (219) of the processed at least one first RF signal; and adjust a phase shift to be applied by the at least one variable phase shifter (420) for phase shifting at least one second RF signal applied to the at least one feed path.

### FIELD OF THE INVENTION

The field of the invention relates to an apparatus and a method for calibrating and compensating for phase mismatch on feeds to an antenna arrangement and, in particular an apparatus and method for calibrating and compensating phase mismatch to generate alternate types of radiated signal polarization.

### BACKGROUND OF THE INVENTION

Conventional antenna arrays, as used in cellular infrastructure macro cells, comprising multiple antenna elements and used with existing Node-B equipment in most third generation (3G) installations, utilize a fixed 65° beam pattern. Outside of the main lobe of the antenna beam the signals are spatially filtered and significantly attenuated. Conventional network planning and passive antenna array solutions process all incoming signals with a common fixed beam pattern. Such receive processing, based on signals received within the geographic area identified by the antenna beam main lobe, referred to as the RF footprint, tends to dictate a corresponding common beam pattern for transmitter operation. Thus, an identical radio frequency (RF) footprint is used for both receive (Rx) and transmit (Tx) operation.

HSPA+, also known as Evolved High-Speed Packet Access is a wireless broadband standard defined in 3GPP release 7 and is an evolution of the third generation (3G) cellular communication standard based on frequency division duplex (FDD) wideband code division multiple access (WCDMA) technology. HSPA+ provides HSPA data rates up to 56 Mbit/s on the downlink and 22 Mbit/s on the uplink with multiple input and multiple output (MIMO) technologies and higher order modulation (64QAM). Recent trials in HSPA+ networks have uncovered a problem with capacity and coverage issues with single antenna UE (User Equipment) devices. The intention of HSPA+ is that it should be backward compatible to all network UEs including those supporting just HSDPA and Release 99 versions of the 3G standard. HSPA+ introduces and utilizes transmit diversity on the Node-B network element.

Network Operators prefer to use polarization diversity for MIMO transmission on HSPA+, such that MIMO signals share the same frequency but different data is modulated on to respective carriers as transmitted over different polarizations. Polarization diversity is preferred over spatial diversity as the antenna can be used at the top of the antenna mast, as for previous versions of the 3G standard. Furthermore, many sites are crowded and room for extra antennae is not available. Field trial results have also shown that the equivalent or better MIMO link gains can be found through use of polarization diversity only.

Network operators and 3GPP standards intend to use a common pilot channel (CPICH) on one of the polarization transmissions and no CPICH on the other. CPICH is used by UE devices in the rake receiver for both the channel equalisation and rake receiver channel estimator. In the absence of a CPICH, for example if it is not transmitted from the node-B, alternate equalisation and rake receiver channel estimator techniques may be employed. Usually an algorithm such as a minimum mean square error (MMSE) algorithm is used to estimate the weights and delays of the Rake receiver in WCDMA based receptions without the CPICH being present.

Many current UEs, will not support new upgrades to the 3G standard and are therefore unable to utilize HSPA+. In particular, recent trials of HSPA+ networks have uncovered a problem due to a use of linear polarization (LP) transmission diversity and its effects on 3G UE devices that do not have the capability of diversity reception. A UE device supporting only older versions of the standard may only have one receive antenna and, thus, will not be able to exploit the transmission diversity of the upgraded network. Such a UE device will obtain its call traffic routed through one of the node B transmit diversity paths only. A problem arises as the UE device is rotated or moved to a location where the second orthogonal transmission from the MIMO enabled Node B becomes much stronger than the desired first orthogonal transmission. This second orthogonal transmission signal then exhibits itself as an uncorrelated noise-like interferer on the UE receiver receiving the first orthogonal transmission. Furthermore, the second orthogonal transmission signal remains as an uncorrelated interferer as such a UE device is not able to process both MIMO transmissions at the same time. The received carrier to interference plus noise ratio (CINR) may degrade the receiver performance by 10's of dBs, thereby causing communication links to be dropped and consequently reducing cell coverage area.

If the MIMO transmission is left-hand circularly polarized (LHCP) and right-hand circularly polarized (RHCP), as opposed to LP +45° and LP −45° polarization, then the impact on legacy 3G UE devices is reduced. This is because the signal to interference is limited to 3 dB, i.e. the signal of both LHCP and RHCP are the same power for all orientations of the UE device antenna. Thus, HSPA+ enabled UE devices do not have their reception adversely affected by use of a CP signal.

Since orthogonal LHCP and RHCP antennas for MIMO (Multiple Input Multiple Output) transmission in network trials has proven to be successful in reducing this problem with single antenna UE devices, this implies that an antenna for the node B must be capable of concurrent transmission in LHCP and RHCP.

Referring now to FIG. 1, examples of known electromagnetic waveforms are illustrated. A first diagram 100 illustrates a linear polarized field from an antenna and a second diagram 150 illustrates a circular polarized field. The polarization of an antenna is the orientation of the electric fields (E-plane) 110 of the radio wave with respect to the Earth's surface and is largely determined by the physical structure of the antenna and by its orientation. The magnetic field (H-plane) 120 is always perpendicular to the E-plane 110. The E-plane 110 and H-plane 120 are respectively illustrated as propagating in the directions 105, 115. In contrast, circular polarized (CP) antennas as illustrated in the second diagram 150 have a rotating E-plane 160 in a propagation direction 155, in contrast to the linear polarized (LP) antennas having a fixed E-plane.

Circular polarization is the polarization of electromagnetic radiation, such that the tip of the electric field vector describes a circle in any fixed plane intersecting, and normal to, the direction of propagation. However, in practical systems there will be minor deviations from this perfect angular electric field vector that describes a circle. For the purposes of the description hereinafter described an E-Field vector that is substantially close to that of a circle is considered to be a circularly polarized field.

Elliptical polarization is the polarization of electromagnetic radiation, such that the tip of the electric field vector describes an ellipse in any fixed plane intersecting, and normal to, the direction of propagation. Elliptical polarized fields can be configured as circularly polarized fields, and can be rotated polarized fields in a clockwise or counter clockwise direction as the field propagates; e.g. forming right hand elliptical polarization and left hand elliptical polarization respectively. An elliptically radiated field will have substantially changed magnitude for 90° change in angular vector.

Cross-polarization (XPOL) antennas are also often used, particularly in cellular infrastructure deployments. XPOL antenna technology utilizes pairs of two LP antenna elements that are orientated substantially 90° with respect to each other, often referred to as being ‘orthogonal’ to each other, usually at +45° and −45° polarization. These pairs are often elements in an array, and thus can be arranged such that a desired propagation beam shape is developed. To date, deployed cellular infrastructure transmit polarization orientation predominantly only uses one of the polarization types whereas receive functionality is performed in both polarizations, with separate and independent processing of the two XPOL receive paths being employed. These XPOL antennas can be of patch construction (PCB) or of Dipole (Wire) construction. Currently, some Network Operators are supporting HSPA+ using two polarizations for the transmission of MIMO signals.

A known problem in using LP transmissions is that the polarization of the transmitted signal antenna and the receiving signal antenna (if also an LP type) needs to have the angle of polarization exactly the same for reception of the strongest signal. For example a signal transmitted on a vertically polarized (VP) antenna and received on an antenna with horizontal polarized (HP) may have 10's of dB difference in received power compared to a matched VP antenna. Mobile handset antennas are generally LP, though increasingly through means of diversity reception paths a second polarization diversity LP antenna is utilized, orthogonally polarized to the first.

However, all existing antenna infrastructure is of a linear cross-polarization type. There is a need to convert signals being fed to a cross polarization antenna and modify them such that they can be broadcast in CP modes using existing antenna infrastructure. Internal feeds to XPOL elements of respective +45° and −45° polarization are not specified or controlled to be matched electrical lengths on existing antennae. Furthermore, cable feeds from the base station or remote radio head to the antenna are typically cut to measure and installed in the field. Consequently, a phase of signals applied to an orthogonal antenna element is unknown. Where XPOL antennas are used to radiate CP signals the phase to the antenna elements needs to be tightly controlled. As a polarized signal may deviate from its ideal 90° difference, then the polarization diversity benefits deteriorate quickly to an elliptical type polarization, thus greatly affecting the performance of communications in the network.

Simple measurement and phase adjustment techniques cannot be used to correct for the above problems, as the termination of the antenna feeds affecting the signal paths is actually made inside the antenna array, i.e. at the radiating elements, and these can not be accessed in an electrical type test. Furthermore, the phase shift may be frequency dependant, especially if there is significant mismatch in cable lengths. In laboratory tests, it has also been found that a difference in torque applied to the cable connectors has a significant impact on the phase response, which can be as much as seven degrees per connector. Thus, any measurements performed prior to installation are insufficient to accurately set phase shift circuitry in the network element prior to the antenna/antenna array. Also, for the above reasons a use of a single phase setting is incapable of guaranteeing an accurate phase of polarization signals from the antenna/antenna array.

U.S. Pat. No. 4,737,793 proposes a microstrip-based XPOL antenna element with two 3 dB hybrid couplers and four radio frequency phase shifters. There is no mention of any adjustment of the phase shifter for the purpose of offsetting mismatch in cable feeds. U.S. Pat. No. 4,737,793 provides no teaching of either a calibration method or a feedback technique, for example using feedback couplers for sensing and updating the phase shifter settings. Furthermore, the use of excessive processing on the signals at the antenna is undesirable, as the losses induced would be excessive and cause noise figure degradation of the receiver performance and an unacceptable loss on the PA output for transmission.

U.S. Pat. No. 6,262,690 proposes a use of a hybrid coupler and a phase shifter at the input to an amplifier pair to adjust a phase of a signal fed to a single antenna element via an orthomode transducer, which is a device that separates signals received from an antenna into their respective received polarization types. The phase shifters are employed to correct for phase offsets induced by the amplifiers.

Furthermore, receiver examples using active panel antenna technology, as exemplified by co-pending application GB0921956.9, utilize a receiver to calibrate and compensate for any phase mismatch between respective antenna feeds of different polarizations to an antenna array. In such examples, the compensation mechanism has to refer back to altering the transmission signal in the digital domain, which is not always possible particularly where the antenna element is physically far removed from the baseband signal generation, which is typically the case in most Node B equipment.

Consequently, current techniques are suboptimal. Hence, an improved mechanism to address the problem of supporting antenna array technology in a wireless communication network would be advantageous.

### SUMMARY OF THE INVENTION

Accordingly, the invention seeks to mitigate, alleviate or eliminate one or more of the above mentioned disadvantages singly or in any combination.

According to a first aspect of the invention, a polarization control device for compensating phase mismatch is described. The polarization control device is operably coupleable via at least two radio frequency (RF) feed paths to an antenna arrangement that comprises at least two orthogonally polarized antenna elements. The polarization control device comprises or is operably coupleable to at least one variable phase shifter located on at least one RF feed path. The polarization control device further comprises a processing module configured to: receive and process at least one first RF signal; determine a phase mismatch between the at least two RF feed paths to the antenna arrangement of the processed at least one first RF signal; and adjust a phase shift to be applied by the at least one variable phase shifter for phase shifting at least one second RF signal applied to the at least one feed path passing there through to the at least two orthogonally polarized antenna elements, based on the determined relative phase mismatch and a desired polarization of the at least one second RF signal to be radiated from the antenna arrangement.

Advantageously, this provides a network element for overcoming the mismatches that result from such cable network installation and antenna corporate feed networks, whilst controlling the polarization of a radiated signal from an antenna arrangement.

In an optional embodiment, the polarization control device may further comprise at least one input port, at least one output port and comprise or be operably coupleable to a hybrid coupler operably coupled to the variable phase shifter for routing RF signals from and to the at least one input port and the at least one output port via the variable phase shifter. Advantageously, this allows for all elements required to convert a linearly polarized XPOL antenna to be operated as a CP mode of antenna radiation for at least one frequency.

In an optional embodiment, the processing module may comprise at least one processor operably coupled to a plurality of receivers for respectively receiving RF signals applied to one or more of the at least one input port and the at least one output port. Advantageously, this allows for a complete mismatch determination encompassed within said processing module signal processing functions.

In an optional embodiment, the polarization control device may further comprise a bypass path coupled to the hybrid coupler, such that the processing module may be capable of routing signals to bypass the hybrid coupler.

Advantageously, this allows for native polarization types to be radiated from antenna arrangement. Furthermore, in one example, if the hybrid functions are performed in other system elements, such a hybrid function could be bypassed in the device.

In an optional embodiment, the at least one variable phase shifter may be operably couplable to a stepper motor, such that the processing module configures the stepper motor to adjust a phase shift (‘α’) to be applied by the at least one variable phase shifter to RF signals passing there through, thereby, not necessitating the use of an intermediary device to control such motor functionality.

In an optional embodiment, the variable phase shifter may be located on each of the at least two RF feed paths, such that the processing module may adjust a phase shift (‘α’) to be applied by the at least one variable phase shifter to RF signals passing through either or both of the at least two RF feed paths.

Advantageously, in the case where each path of the variable phase shifter is adjusted, the losses and hardware associated can be limited to substantially half that of the at least two RF feed paths. In the case of both paths having a phase shift function applying symmetrical signal processing to each of the feed lines to the antenna arrangement, it may be possible to equalise any losses associated therewith.

In an optional embodiment, at least two frequency separated RF signals may be routed via the at least two RF feed paths from the antenna arrangement, such that the processing module is arranged to determine the phase mismatch between the at least two RF feed paths to the antenna arrangement for each of the respective frequency separated RF signals.

In an optional embodiment, the processing module may be configured to adjust the phase shift to be applied to the variable phase shifter as a function of frequency. In an optional embodiment, the processing module may be arranged to adjust the phase shift to be applied to the variable phase shifter based on a function of phase mismatch between the at least two RF feed paths to the antenna arrangement where the phase mismatch is more than one 360° cycle of phase difference

In an optional embodiment, the at least two RF feed paths comprise a co-polarization feed and a cross-polarization feed between the polarization control device and the antenna arrangement.

In an optional embodiment, the at least one first RF signal is routed via the at least two RF feed paths from an antenna arrangement, such that the processing module may be arranged to determine a relative phase mismatch between the at least two RF feed paths to the antenna arrangement. In an optional embodiment, the first RF signal may be sourced from a signal source coupled to a radiative source placed in a far-field of known polarization. In an alternative optional embodiment, the first RF signal is sourced from a signal source coupled to a radiative source placed in a near-field of known polarization.

Advantageously, this allows generation of a known polarized signal from which the antenna arrangement and associated feeds can be calibrated.

In an optional embodiment, a desired polarization type of the RF signals may comprise at least one from a group consisting of: (i) a cross polarization type; (ii) a circularly polarization (CP) type, such as left hand CP, right hand CP; (iii) a linear polarization (LP) type; (iv) an elliptical polarization type. Advantageously, this facilitates a high degree of optimal polarization types to be processed by antenna arrangement.

According to a second aspect of the invention, an integrated circuit for a polarization control device for compensating phase mismatch is described. The polarization control device is operably couplable via at least two radio frequency (RF) feed paths to an antenna arrangement that comprises at least two orthogonally polarized antenna elements, the polarization control device operably coupleable to at least one variable phase shifter located on at least one RF feed path. The integrated circuit comprises a processing module arranged to: receive and process at least one first RF signal; determine a relative phase mismatch between the at least two RF feed paths to the antenna arrangement of the processed at least one first RF signal; and adjust a phase shift to be applied by the at least one variable phase shifter for phase shifting at least one second RF signal applied to the at least one feed path passing there through to the at least two orthogonally polarized antenna elements, based on the determined relative phase mismatch and a desired polarization of the at least one second RF signal to be radiated from the antenna arrangement. Advantageously, this allows for the integration of such a device to minimise power consumption and reduce cost and or physical dimensions.

According to a third aspect of the invention, a method for compensating phase mismatch between a polarization control device and an antenna arrangement, coupleable via at least two radio frequency (RF) feed paths, is described. The method comprises receiving and processing at least one first RF signal; determining a relative phase mismatch between the at least two RF feed paths to the antenna arrangement of the processed at least one first RF signal; and adjusting a phase shift to be applied to at least one second RF signal applied to the at least one feed path passing there through to the at least two orthogonally polarized antenna elements based on the determined relative phase mismatch and a desired polarization of the at least one second RF signal to be radiated from the antenna arrangement. Advantageously, this allows for the method to be employed via means where network element components are not on a same device.

According to a fourth aspect of the invention, a tangible computer program product comprising executable program code stored therein for compensating phase mismatch using a polarization control device, is described. The executable program code is operable for performing the method of the third aspect of the invention.

These and other aspects, features and advantages of the invention will be apparent from, and elucidated with reference to, the embodiments described hereinafter.

### BRIEF DESCRIPTION OF THE DRAWINGS

Embodiments of the invention will be described, by way of example only, with reference to the accompanying drawings, in which

FIG. 1 shows electromagnetic waveforms illustrating a linear polarized field and a circular polarized field.

FIG. 2 illustrates an example of a 3GPP cellular communication system adapted in accordance with some embodiments of the invention.

FIG. 3 illustrates a simplified example of a part of a communication architecture comprising a polarization control device.

FIG. 4 illustrates an example of a polarization control device.

FIG. 5 illustrates a graphical example of feeder cable mismatch vs. phase difference.

FIG. 6 illustrates an example of a flowchart for calibrating the polarization control device.

FIG. 7 illustrates a typical computing system that may be employed to implement signal processing functionality in embodiments of the invention.

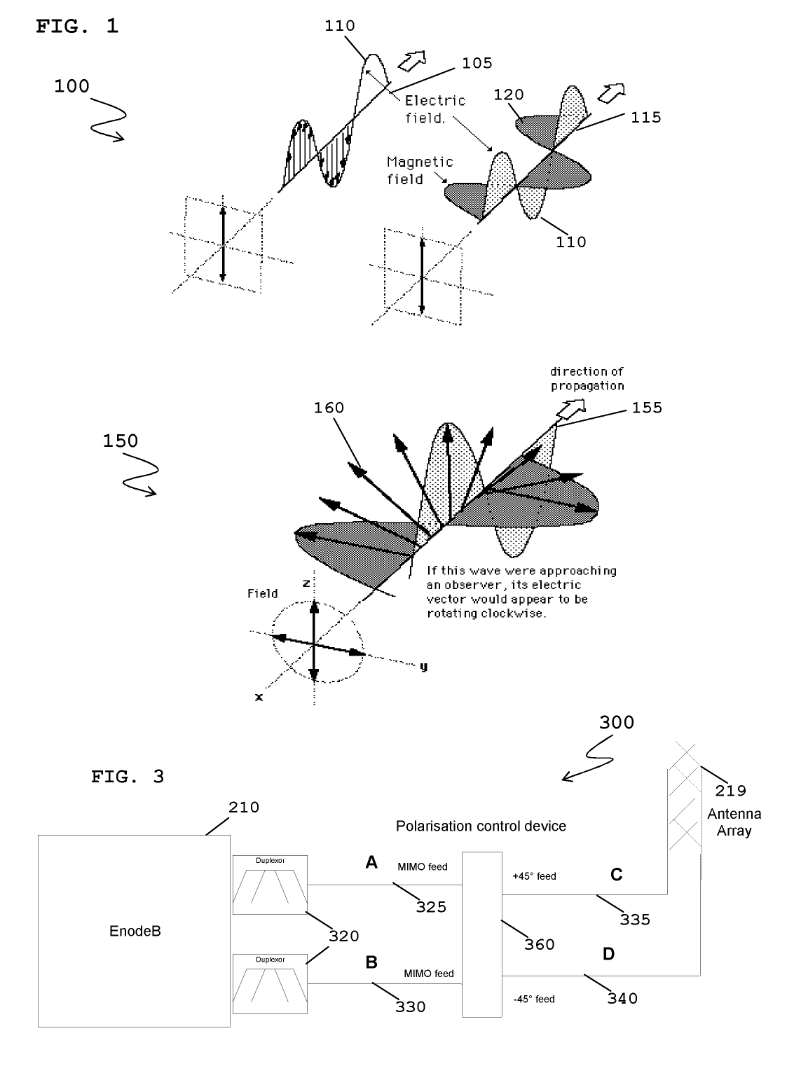

### DETAILED DESCRIPTION OF EMBODIMENTS OF THE INVENTION

In the described examples, a reference to a native polarization of an antenna encompasses the polarization of a signal processed by one antenna element acting independently of at least one other antenna element. In the XPOL (cross polarization) example cited heretofore the native polarization would be LP (linear Polarized)+45° and LP −45°. Independent signals processed by these antenna elements will undergo no polarization transformation. When a modified version of the same signal is processed concurrently in antenna elements of both polarizations, and through combining forms a different polarization type, then this is referred to as non-native.

Modern air-interface protocols exploit antenna diversity to improve the air interface communication link. Thus, conventional antenna arrangements, and particularly antenna arrays contain an array of radiative antenna elements of for example +45° and −45° LP orthogonal polarization.

In network element-to-antenna array configurations it is known that the cable feed between an antenna array and a NodeB will affect the phase of transmitted/received signals. Where an antenna is transmitting or receiving with its native polarization, such a cable feed phase issue has previously been deemed to be relatively unimportant, as there is generally no desire to match elements of orthogonal polarization. In passive antenna array systems with elements of a common polarization, the phase and amplitude of paths/signals should be accurately controlled to individual elements of the array via the antenna array's corporate feed network in order to control the beam of a radiated signal. Passive antenna arrays, such as those deployed in cellular infrastructure, use this method (or similar methods) of control to generate a desired beam of required polarization. There is generally not a need to match the corporate feed network on one polarization with that in the orthogonal, where native polarizations only are processed.

Example embodiments of the invention utilize one or more receivers and associated processing functionality to sense signals in a calibration process to compensate for any phase mismatch between respective antenna cable feeds to antenna elements, particularly antenna elements of orthogonal polarizations in an antenna array generating a non-native polarization type. In one example, the phase match may be performed from the output of a 3 dB Hybrid coupler element or function. As is known in the art couplers and hybrid couplers are devices in which two transmission lines pass close enough to each other for energy propagating on one line to radiatively or conductively couple to the other line. A 3 dB 90° or 180° hybrid coupler splits an input signal into two substantially equal amplitude outputs with either a substantially 90° or 180° phase difference in output signals. For the purposes of embodiments described herein a conductively coupled 90° hybrid is considered. However, in some example embodiments, the radiatively coupling 90° hybrid may be used.

Furthermore, and in the described example, a 3 dB hybrid coupler has one substantially isolated port from each input, thereby facilitating isolation of input signals from both respective Node B transmitters and of antenna inputs from orthogonal polarization ports. In this regard, a polarization control device is described, which when configured to be part of the interconnect path between the output of a NodeB and an antenna arrangement may provide a phase modification to transmit or receive signals there between. In addition, the polarization control device may be configured to adjust for phase mismatch, in order to generate at least one non-native polarization type. In some examples, a portion of signals relayed between the antenna array and a NodeB are coupled off and routed to down-conversion and signal processing circuitry, processed digitally in one example in order to provide a determination of an adjustment signal for controlling a phase shift of one or more of the paths of a variable phase shifter located between the antenna array and the 3 dB Hybrid coupler operably coupled to the NodeB, for example located in the polarization control device.

In some example embodiments, the variable phase shifter may be replaced by any RF element that is able to apply a phase adjustment to a signal passing there through.

In one example embodiment, the polarization control device 360, or RF circuitry coupled to the polarization control device 360, may comprise selectable bypass circuitry, which may be utilized in scenarios when a phase adjustment is neither required nor desired. In one example embodiment, the selectable bypass circuitry may comprise a mechanism for disabling the 3 dB hybrid coupler, thus allowing signals to be forwarded to the antenna arrangement without undergoing a hybrid coupler transformation process. In one example embodiment, the hybrid coupler disabling may be achieved using one or more bypass switches with a selectable (alternative) path arranged to by-pass the 3 dB hybrid coupler.

In one example, calibration of any phase mismatch determination is based on a use of a known polarization source; for example a vertical polarization (VP) source; of a two-tone signal being applied via a remote antenna. For example if the cable and corporate feed network were perfectly matched, a 180° phase shift signal would exist, as observed at the output of the cable feeds at the antenna array and prior to a 3 dB hybrid function with a VP source and a +45° and −45° LP orthogonal polarization network antenna arrangement.

Since example embodiments of the invention can relate to any orthogonally polarized antenna arrangement, examples of the invention are equally relevant to UE or any handset receiver device.

The following description focuses on embodiments of the invention that are applicable to active antenna arrays employed in Universal Mobile Telecommunication System (UMTS) cellular communication systems and in particular to a UMTS™ Terrestrial Radio Access Network (UTRAN) operating in a 3^{rd} generation partnership project (3GPP™) system, and evolutions to this standard such as HSPA+. However, it will be appreciated that the invention is not limited to this particular cellular communication system, but may be applied to any wireless communication system, including satellite communication systems, employing antenna arrangements, where at least one orthogonal pair of antenna elements are used.

In the examples herein described, an antenna element is a radiative structure whose purpose is to convert electro-magnetic (EM) signals to electrical signals, or vice versa, in which a singular element has a fixed radiation pattern. The term ‘radiative elements’ described herein refers to elements capable of radiating an electromagnetic signal. Furthermore, the term ‘radiative elements’ described herein also encompasses structures capable of absorbing EM radiation and converting to electrical signals. These elements, constructed as an array can be configured to have various radiation patterns or polarizations by manipulation of electrical signals coupled to the elements. Thus, the ability to alter the radiative beam shape or polarization may be achieved.

For completeness, it is worth clarifying the Antenna Reciprocity Theorem, which in classical treatises on electromagnetic fields and antennas is usually formulated as follows:

Given two antennas ‘A’ and ‘B’ placed at some distance apart, each of them may be operated either as a transmitting antenna or as a receiving antenna. Suppose that antenna ‘B’ is kept intact, whilst the performance of antenna ‘A’ as a transmitter is modified. A consequence of this is that, for a fixed amount of input power, the signal received by antenna ‘B’ changes by a factor ‘F’ due to the change imposed on antenna ‘A’. Then the same modification changes also the performance of antenna ‘A’ as a receiver and does so by the same factor ‘F’. The theorem follows from certain symmetries of Maxwell equations and its validity is easily verified experimentally and has been widely published. Hence, the radiation pattern induced by a transmitter operably coupled to an antenna with same carrier frequency as a receiver has identical azimuthal angular link loss. Thus, the term radiative and ‘radiative beam pattern’ used hereinafter may also be applied to a receiver.

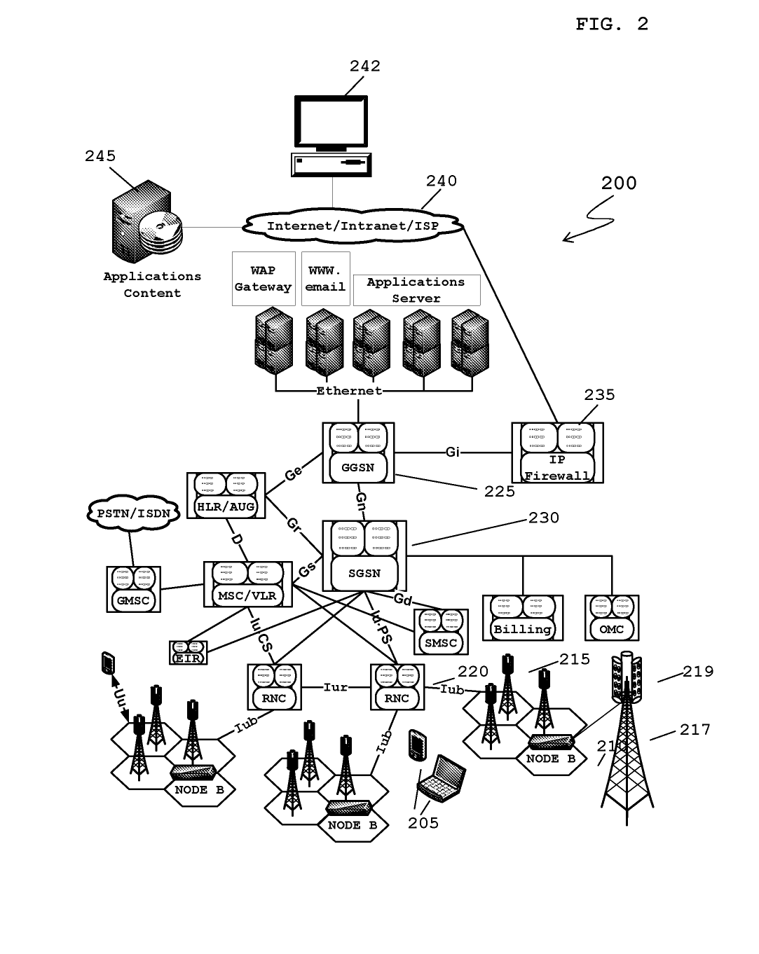

Referring now to FIG. 2, a cellular-based communication system 200 is shown in outline, in accordance with one embodiment of the invention. In this embodiment, the cellular-based communication system 200 is compliant with, and contains network elements capable of operating over an universal mobile telecommunication system (UMTS™) air-interface or any evolution of said air interface access method.

A plurality of wireless subscriber communication units/terminals (or user equipment (UE) in UMTS™ nomenclature) 205 communicate over radio links with a plurality of base transceiver stations, referred to under UMTS terminology as Node-Bs, 215 supporting communication coverage over a particular communication cell 210. The system 200 comprises many other UEs and Node-Bs, which for clarity purposes are not shown.

The wireless communication system, sometimes referred to as a Network Operator's Network Domain, is connected to an external network 240, for example the Internet. The Network Operator's Network Domain includes:

(i) A core network, namely at least one Gateway General Packet Radio System (GPRS) Support Node (GGSN) 225 and at least one Serving GPRS Support Nodes (SGSN) 230; and

(ii) An access network, comprising a UMTS Radio network controller (RNC) 220; and at least one UMTS Node-B 215, where each RNC 220 may control one or more Node-Bs 215.

The GGSN 225 or SGSN 230 is responsible for UMTS interfacing with a Public network, for example a Public Switched Data Network (PSDN) (such as the Internet) 240 or a Public Switched Telephone Network (PSTN). The SGSN 230 performs a routing and tunnelling function for traffic, whilst a GGSN 225 links to external packet networks. Each SGSN 230 provides a gateway to the external network 240. The Operations and Management Centre (OMC) is operably connected to RNCs 220 and Node-Bs 215. The OMC comprises processing functions and logic functionality in order to administer and manage sections of the cellular communication system 200, as is understood by those skilled in the art.

The Node-Bs 215 are connected to external networks, through Radio Network Controller (RNC) stations, including RNC 220 and mobile switching centres (MSCs), such as SGSN 230. A cellular communication system will typically have a large number of such infrastructure elements where, for clarity purposes, only a limited number are shown in FIG. 2.

Each Node-B 215 contains one or more transceiver units and communicates with the rest of the cell-based system infrastructure via an I_{ub} interface, as defined in the UMTS™ specification. Each Node-B 215 is operably coupled to an antenna mast 217 for transmitting and receiving signals to/from remote UEs, where each antenna mast 217 comprises an antenna array 219.

In accordance with example embodiments of the invention, a polarization control device is incorporated between the Node-B and the antenna array 219, as described in greater detail below with respect to FIG's 3-6. In accordance with some example embodiments of the invention, active array technology is employed in the cellular communication system 200.

Referring now to FIG. 3, and in accordance with example embodiments of the invention, a polarization control device 360 is incorporated between a base station, such as a NodeB or an evolved (e)NodeB 210 and an antenna array 219. The eNodeB 210 comprises multiple input multiple output (MIMO) paths to the antenna array 219, with two MIMO paths illustrated for clarity purposes only. Each MIMO path comprises a duplexor 320 located at the output of the eNodeB 210. The purpose of the duplexor is to isolate transmit signals from the receive signals, as processed by the eNodeB 210, thereby advantageously allowing receive and transmit to be processed independently in the eNodeB 210. Thus, the polarization control device 360 comprises two ports ‘A’ and ‘B’ coupled to first and second MIMO feeds 325, 330, which receive output signals from, or input signals to, duplexors 320. The polarization control device 360 also comprises two ports ‘C’ and ‘D’ coupled to a −45° feed 335 and a +45° feed 340, which receives input signals from, or outputs signals to a XPOL antenna array 219.

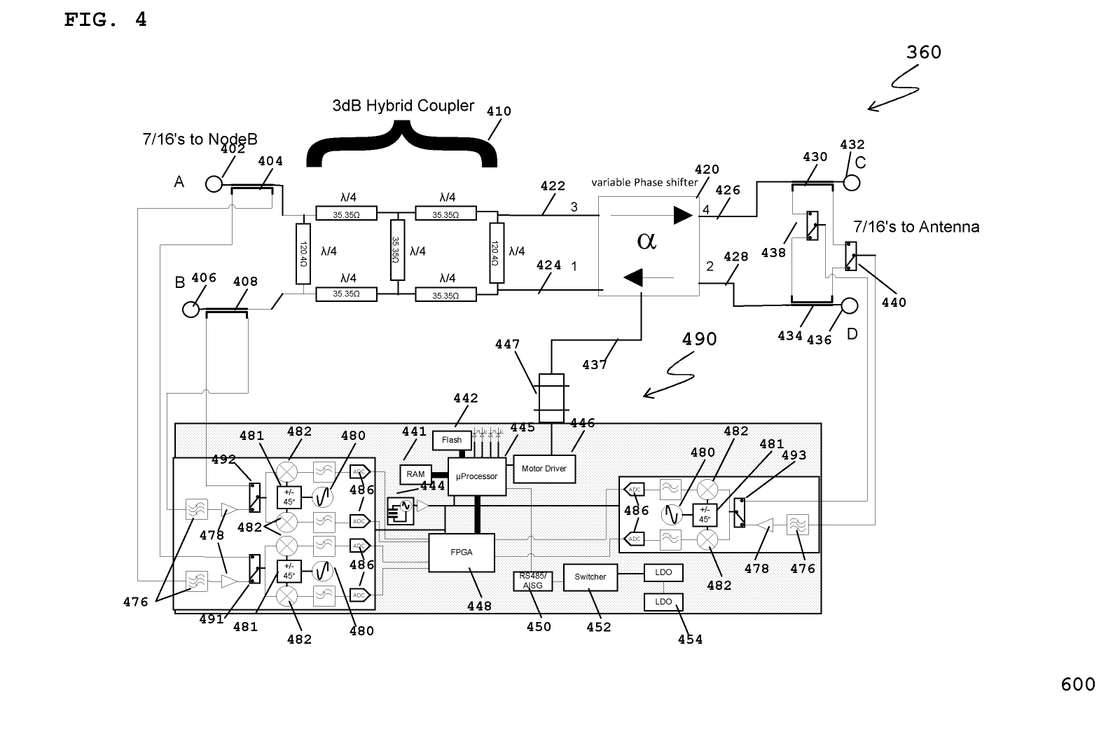

Referring now to FIG. 4, a more detailed example of the polarization control device 360 is illustrated, in accordance with exemplary embodiments of the invention. In some example embodiments, the polarization control device comprises one, some or all of the RF circuit elements, as well as the one, some or all of the receiver, baseband processing and control functions or logic elements. In some example embodiments, the polarization control device may only comprise one, some or all of the receiver, baseband processing and control functions or logic elements, configured to be operably coupleable, and provide control signals to, one, some or all of the RF circuit elements, such as phase shift control or control signals to control the operation of one or more of the RF switches. In some example embodiments, one, some or all of the receiver, baseband processing and control functions or logic elements may be implemented on one or more integrated circuit(s).

In the example embodiment illustrated in FIG. 4, cross polarized (XPOL) antenna elements that are of an orthogonal polarization linear type employing both +45° and −45° are used, with respective independent transceiver antenna paths connected to each port of the antenna element. In one example embodiment, the polarization control device 360 may be employed as a network element coupling a base station, such as eNodeB 210 to an antenna arrangement, such as antenna array 219. In one example, the polarization control device 360 may be located in the tower base adjacent to a Node B base station, or at tower top and co-located with a remote radio head connected to the antenna arrangement. In one example, the polarization control device 360 includes a processing unit 490. In one example the polarization control device 360 may include a connector to host a processing unit 490; such that the processing unit may be disengaged once signal processing steps are completed.

The polarization control device 360 comprises two ports ‘A’ 402 and ‘B’ 406 coupled to first and second MIMO feeds, for example first and second MIMO feeds 325, 330 of FIG. 3, which receive output signals from, or input signals to, duplexors 320. In polarization control device 360 the two ports ‘A’ 402 and ‘B’ 406 are connected to respective directional couplers 404, 408, arranged to couple off a portion of signals appearing on ports ‘A’ 402 and ‘B’ 406. The directional couplers 404, 408 are connected to processing unit 490.

The polarization control device 360 also comprises a 3 dB hybrid coupler 410 located in the paths between the base station (for example eNodeB 210 in FIG. 3) and the antenna arrangement (for example antenna array 219 in FIG. 3). A 3 dB hybrid coupler 410 is preferred in providing a splitting of a received signal whilst concurrently providing a 90 degree phase shift, as losses are minimised within such a 3 dB hybrid coupler structure. In one example, the 3 dB hybrid coupler 410 (as shown in FIG. 4) may be constructed as a branch line structure, which can be made for example on a printed circuit board using coupling branches in microstrip or stripline controlled impedance traces. In other examples, other means of producing 3 dB hybrid structures may be used, for example using rat race and Lange constructions.

Two ports of the 3 dB hybrid coupler 410 are respectively operably coupled to directional couplers 404, 408 on a first side and two ports respectively operably coupled to two ports 422, 424 of a variable phase shifter 420 on the other side. As known, in a transmit mode of the 3 dB hybrid coupler 410, signals on port ‘A’ 402 and/or port ‘B’ 406 are split evenly between port ‘C’ 422 and port ‘D’ 424, and similarly in a receive mode the signals on port ‘C’ 422 or port ‘D’ 424 are split evenly between port ‘A’ 402 and port ‘B’ 406. As also known and illustrated in FIG. 4, a signal input to port ‘A’ 402 or port ‘B’ 406 is split evenly between port ‘C’ 422 and port ‘D’ 424, notably with a 90 degree phase difference between respective ports. Consequently, as the 90 degree phase shift is generated within the polarization control device using the 3 dB hybrid coupler 410, the polarization control device need only manage the phase mismatch (which may be referred to as a delay) between itself (at the 3 dB hybrid coupler 410) and the antenna or antenna array 219. Thus, signals to and from the Node B 210 to the polarization control device 360 need not be calibrated or matched.

The variable phase shifter 420 comprises a further two ports 426, 428 operably coupled to ports ‘C’ 432 and ‘D’ 436 of the polarization control device 360. Again, the two ports ‘C’ 432 and ‘D’ 436 of the polarization control device 360 are connected to respective directional couplers 430, 434, arranged to couple off a portion of signals appearing on ports ‘C’ 432 and ‘D’ 436. The directional couplers 430, 434 are connected to processing unit 490 via a switching arrangement comprising first and second single pole double throw switches 438, 440. In this manner, the polarization control device 360 is able to receive the coupler sensed signals that are output to (or received from) the antenna arrangement.

The processing unit 490 performs down conversion of RF signals as sensed by the couplers 408, 404, 430, 434 and comprises one or a plurality of feedback receivers, as shown. In an example employing a plurality of feedback receivers, each receiver may consist of a band-pass filter 476, an optional low noise amplifier (LNA) 478, down-conversion stages 482 arranged to down-convert the respective amplified received signals based to a frequency down-conversion signal. Down conversion signals are fed in quadrature format from a local oscillator generation sub-system 480, 481. The respective quadrature down-converted amplified received signals are input to respective low-pass filters and thereafter to respective analogue-to-digital converters (ADCs) 486 to transform the quadrature down-converted received signal to a digital form. The outputs from the respective ADCs 486 are input to field programmable gate array (FPGA) 448. In one example, FPGA 448 is arranged to perform filtering, decimation and Direct Current voltage Offset Correction (DCOC) on the received signals under different mode of operation. DCOC may be used to allow accurate measurements of signals to be achieved by removing a DC component.

The FPGA 486 and feedback receivers receive a clock signal generated by clock circuitry 444. The FPGA 486 is operably coupled to a micro-processor 445, which in this example is operably coupled to a random access memory (RAM) 441, which may be used for storage space during the execution of calibration algorithms, and (non-volatile) flash memory 442 (used for storing data whilst the memory is un-powered). Thus, in this example, the flash memory 442 may be used for the storage of computer code for the execution of the algorithms, as well as for storing the status and results of calibrations already run, and in some examples storing details of the last motor position.

The micro-processor 445 performs a variety of operational functions, including by way of example, digital signal processor (DSP) related algorithmic solutions, motor drive control and event scheduling and communications via the serial Antenna Interface Standards Group (AISG™) interface. The AISG™ interface standard specifies, for example, the connector, voltage levels and communications protocol that is used for powering and controlling equipment and tower top components in cellular infrastructure deployments, including, for example, Remote Electrical Tilt (RET) antennae. AISG™ allows electrical power to be provided over the connector in a form of 10V to 30V Direct Current (DC) supply to power for the processing unit 490. The micro-processor 445 also provides control of a RS485-based communications interface used as the signalling means for communicating with a remote AISG™ master device. Such an AISG™ master device is often included as part of the Node B, such that the Node B is able to accept controls from an operations and management centre (OMC). It will be appreciated that in alternative example embodiments, other interfaces may be employed.

In one example, the FPGA 486 and micro-processor 445 cooperate to determine a phase difference between signals on ports ‘C’ 432 and ‘D’ 436, as detected by the antenna arrangement and as received in the polarization control device 360, thereby taking into account mismatches in electrical length of associated feed network. In response to the determined phase relationship, the micro-processor 445 determines a phase shifter position corresponding to a motor movement by configuring the motor driver 446 actuating the motor to automatically adjust the phase shift ‘a’ of the variable phase shifter 420.

Motor driver circuits are used to excite the armatures of the motor 447, and in some examples include high current switches in a H-bridge configuration. The motor driver 446 may also include an ability to change direction of the motor by changing a direction of the current in the armatures. In an example case where stepper motors are used, different modes of operation may be employed such as micro-step modes, where the current is modulated to generate steps smaller than a full step and/or where different coil winding may be selected.

In one example, the variable phase shifter 420 may be an electromechanical type employing a motor 447 to actuate the phase response. This variable phase shifter 420 may use a transmission line (first path) that is capable of being stretched or contracted relative to the second path, to correspond with a phase response that is required by the polarization control device 360. An electromechanical type phase shifter is used in preference to a phase shifter using solid state devices, as solid state device based phase shifters, such as for example a PIN diode based embodiment would result in much greater inter-modulation product generation, such that it that would affect other users of the spectrum and possibly violate spectral emission requirements of the base station. It will be appreciated by skilled artisans that alternate embodiments of phase shifters will not alter the teachings of the invention described herein. Furthermore, in the embodiments described herein the phase shifter may comprise an adjustment on both signals routed to ports ‘C’ 432 and ‘D’ 436 of polarization control device 360. In an alternative example, the adjustments may be performed on only one of either of the signals routed to ports ‘C’ 432 and ‘D’ 436 of polarization control device 360.

In one example, an integrated circuit for the polarization control device may be used to perform the processing operations for compensating phase mismatch between base station 210 and antenna arrangement 219. In this context, the integrated circuit may comprise one or more receivers for example processing units 490 arranged to receive and process at least one down-converted radio frequency signal routed on at least two paths between the base station 210 and antenna arrangement 219. The integrated circuit may comprise processor 445 arranged to determine a phase difference of the at least one down-converted radio frequency signal between the at least two paths; and arranged to adjust a phase setting of a phase shifter 420 to be applied to at least one radio frequency signal on at least one of the at least two paths.

In operation, in one example, the polarization control device 360 is able to convert two MIMO transceiver paths to be transmitted in a CP mode of operation. In one example, the polarization control device 360 is also capable of determining the mismatch on the feeder cables between the polarization control device 360 and the elements of antenna array (for example antenna array 219 of FIG. 3). The transmit situation is considered for reference. The input signal stimuli voltage at port ‘A’ 402 and port ‘B’ 406 are defined by equation [1] and equation [2] below:

EA(t)=A·e^{j·2·πf1t} [1]

EB(t)=B·e^{j·2·πf2t} [2]

The outputs of the 3 dB Hybrid coupler 410 can then be defined as:

$$\begin{matrix}Hybrid 1 \_D ( t ) = \frac{A \cdot {e}^{j \cdot 2 \cdot π \cdot f 1 t}}{\sqrt{2}} + \frac{( B \cdot {e}^{j \cdot 2 \cdot π \cdot f 2 t} ) \cdot ( 0 + j )}{\sqrt{2}} & [ 3 ] \\ Hybrid 1 \_C ( t ) = \frac{B \cdot {e}^{j \cdot 2 \cdot π \cdot f 2 t}}{\sqrt{2}} + \frac{( A \cdot {e}^{j \cdot 2 \cdot π \cdot f 1 t} ) \cdot ( 0 + j )}{\sqrt{2}} & [ 4 ]\end{matrix}$$

The 3 dB Hybrid coupler 410 splits both input signals equally to ports 422, 424. The 3 dB Hybrid coupler 410 also applies a 90° phase rotation to one of the paths, denoted by the +j operator in equation [3] and equation [4].

The variable phase shifter 420 applies a phase adjustment on one or both of the variable phase shifter 420 outputs, to ensure a relative phase difference between the phase shifter outputs. In one typical example, the phase adjustment is applied by making one of the paths longer or shorter relative to the other, thereby effecting a radio frequency phase difference applied to signals passing there through. The signals at the output of the polarization control device 360 may then be described by the following equations:

$$\begin{matrix}{Hybrid1\_D}^{′} ( t ) = \frac{( j \cdot sin ( α \cdot \frac{f 1}{2 \cdot π} ) + cos ( α \cdot \frac{f 1}{2 \cdot π} ) ) \cdot A \cdot {e}^{j \cdot 2 \cdot π \cdot f 1 t}}{\sqrt{2}} + \frac{( B \cdot {e}^{j \cdot 2 \cdot π \cdot f 2 t} ) \cdot ( 0 + j ) \cdot ( j \cdot sin ( α \cdot \frac{f 2}{2 \cdot π} ) + cos ( α \cdot \frac{f 2}{2 \cdot π} ) )}{\sqrt{2}} & [ 5 ] \\ {Hybrid1\_C}^{′} ( t ) = Hybrid1\_C ( t ) & [ 6 ]\end{matrix}$$

Equations [5] and [6] are defined such that the relative phase adjustment is applied to one path only, whereas a realisation of this circuit in some examples may have half of the ‘α’ phase shift/time difference applied to each path.

Let us consider one example case where a time delay mismatch ‘Θ’ (in time) exists on the feeder cable to the antenna(e) elements/antenna array. The resultant signal output to the polarization control device 360 is defined below by equation [7], for the −45° input to the antenna element.

$$Xpol\_feed ( t ) = \frac{[ \begin{matrix}j \cdot sin [ ( α + θ ) \cdot \frac{f 1}{2 \cdot π} ] + \\ cos [ ( α + θ ) \cdot \frac{f 1}{2 \cdot π} ]\end{matrix} ] \cdot A \cdot {e}^{j \cdot 2 \cdot π \cdot f 1 t}}{\sqrt{2}} + \frac{( B \cdot {e}^{j \cdot 2 \cdot π \cdot f 2 t} ) \cdot ( 0 + j ) \cdot [ \begin{matrix}j \cdot sin [ ( α + θ ) \cdot \frac{f 2}{2 \cdot π} ] + \\ cos [ ( α + θ ) \cdot \frac{f 2}{2 \cdot π} ]\end{matrix} ]}{\sqrt{2}} \qquad [ 7 ]$$

In this example, the co-Pol feed (for example the −45° feed 335 of FIG. 3) can be maintained as a reference signal, such that the reference path phase response is the same as in equation [6] and is described below:

$$CoPol\_feed ( t ) = \frac{B \cdot {e}^{j \cdot 2 \cdot π \cdot f 2 t}}{\sqrt{2}} + \frac{( A \cdot {e}^{j \cdot 2 \cdot π \cdot f 1 t} ) \cdot ( 0 + j )}{\sqrt{2}} \qquad [ 8 ]$$

The polarization control device (via the signal coupling, processing unit 490 and FPGA 448/microprocessor 445 control of the motor driver 446) adjusts a in order to allow:

the term

$$j \cdot sin ( ( α + θ ) \cdot \frac{f 1}{2 π} )$$

to be substantially zero and correspondingly

the term

$$cos ( ( α + θ ) \cdot \frac{f 1}{2 π} )$$

to be substantially unity.

In this manner, the signal output from the polarization control device 360 provides approximately perfect signals for generation of a radiated CP signal.

In one example, a calibration is performed to measure the (cable) feed network phase difference between orthogonal ports of the antenna array. Noting that the cable mismatch between antenna feeds is unknown at this point, the polarization control device 360 may be configured to cancel the signals at port ‘A’ 402 or port ‘B’ 406 by the 3 dB Hybrid coupler 420. Hence, in this example, the stronger of the two signals at either port ‘A’ 402 or port ‘B’ 406 is selected. For example, if the signal at port ‘A’ 402 is selected, then the algorithm run by microprocessor 445 compares the phase of the signal at port ‘A’ 402 with the signal at port ‘C’ 432 and compares the signal or phase of the signal at port ‘A’ 402 with the signal or phase of the signal at port ‘D’ 436. The microprocessor 445 is then able to determine a difference between both results, for example after applying a conversion from Cartesian I-Q format to polar magnitude phase using a COordinate Rotation Digital Computer (CORDIC) Arctan function. An ArcTan function is used to convert Cartesian ‘I’ and ‘Q’ values to a phase value and may be efficiently implemented using a CORDIC algorithm. In this manner, microprocessor 445 is able to calculate a phase mismatch between a signal at port ‘C’ 432 and the signal at port ‘D’ 436. Thereafter, microprocessor 445 is able to determine a phase mismatch compensation to be applied to the variable phase shifter 420 via accurate control of the operation of the motor 447.

Advantageously, the variable phase shifter 420 output can be calibrated in a manner that facilitates a closed loop control of phase shifts. In addition, by applying a phase adjustment on one or more of the antenna feed paths, it is possible for the microprocessor 445 to optimise polarization at the output of the antenna to include at least one from a group consisting of: LP, CP and elliptical polarization.

In one example, the directional couplers 408, 404, 430, 434 have two coupled ports for sensing signals propagating in either direction through the polarization control device. The receiver can be configured to receive signals on a direction between the Node B and the antenna or from the antenna to the Node B, as facilitated by switches 491, 492 and 493 that are controlled (not shown) to select the receiver sensing paths.

In one example, the signal processing functions/operations in the FPGA 448 and microprocessor 445 can determine from such received signals the idealised reference output, as can be observed at port ‘D’ 436 and port ‘C’ 432. In one example, the received signals, as sensed on port ‘D’ 436 and port ‘C’ 432, can be compared with the idealised reference and can be used to make a refinement to the setting of the variable phase shifter 420, in order to generate a signal that is substantially close to the ideal reference, and thus capable of being referenced in the in-service calibration.

In a further example, a calibration is performed using two frequencies (instead of the above example of one frequency) to measure the (cable) feed network phase difference between orthogonal ports of the antenna array. Noting that the cable mismatch between antenna feeds is unknown at this point, the polarization control device 360 may be configured to cancel the signals at port ‘A’ 402 or port ‘B’ 406 by the 3 dB Hybrid coupler 420. Hence, in this example, the stronger of the two signals at either port ‘A’ 402 or port ‘B’ 406 is selected. For example, if the signal at port ‘A’ 402 is selected, then the algorithm run by microprocessor 445 compares the phase of the signal at port ‘A’ 402 with the signal at port ‘C’ 432 for a first of the two frequencies and compares the signal at port ‘A’ 402 with the signal at port ‘D’ 436 for the same first frequency. The microprocessor 445 is then able to determine a difference between both results, for example after applying data conversion using a CORDIC Arctan function for that first frequency. For this two frequency example, if the signal at port ‘A’ 402 is selected again using a second frequency, then the algorithm run by microprocessor 445 compares the phase of the signal at port ‘A’ 402 with the signal at port ‘C’ 432 for the second of the two frequencies and compares the signal at port ‘A’ 402 with the signal at port ‘D’ 436 for the same second frequency. Thereafter, microprocessor 445 is able to determine a phase difference between both results, for example after data conversion using a CORDIC Arctan function for the second frequency.

In this example, the phase difference result between the ports at the two different frequencies can be used to algorithmically determine the desired phase compensation term to be employed across a wide range of frequencies. This may be achieved by using both results and, for example, linearly extrapolating the phase response as a function of operating frequency of the device. Advantageously, such a two frequency example allows for phase response to be compensated over a wider bandwidth than the single frequency example. In addition, the two frequency example can also be used to determine the phase response across multiple wavelengths of mismatch.

In one example, the installation calibration program may be initiated on a first power up in the field as part of the installation procedure.

In one example, a two-tone signal source may be transmitted in the far-field of a known polarization to the antenna being installed.

In one example, a VP signal may be used for a +/−45° XPOL antenna arrangement, thereby ensuring that a relative phase mismatch can be determined. The hybrid coupler 410 in the polarization control device 360 equally divides the VP signal received by a +/−45° XPOL antenna between both antenna polarizations, thereby ensuring that a 180° phase difference exists between elements. In other examples, other known polarizations may also be employed, such as RHCP, the difference being that in such an alternative example a 90° phase shift would exist.

As illustrated with respect to FIG. 4, four-port directional couplers 404, 408, 430, 434, may be employed in the polarization control device 360 at each port. These four-port directional couplers 404, 408, 430, 434, provide signals to be fed back to the respective receivers. When running the installation calibration program, a respective receiver path through the LNAs is selected, with the LNA connected to the coupler port for signal propagation in the direction from the antenna to the Node B for the purposes of installation calibration.

In one example, two carrier frequencies are radiated to the antenna array from a known polarized antenna for the purpose of calibration. As mentioned, in one example, the known polarized antenna may be placed in the far-field of the antenna array. The far-field region is the region outside the near-field region, where the angular field distribution is essentially independent of distance from the source. In the far field, the shape of the antenna pattern is independent of distance. If the source has a maximum overall dimension D (maximum perpendicular size of antenna in the case of most cellular deployed antenna arrays) that is relatively large compared to the wavelength λ, the far-field region is commonly taken to exist at distances from the source, greater than Fresnel parameter S=D²/(4λ).

In other examples, an apparatus capable of sending a known polarized signal to the antenna array under test may be used, such as a waveguide probe or a leaky feeder. In further examples, near-field sources can also be used if they can produce a plane-wave stimuli to the antenna under calibration. The near field is that part of the radiated field that is below distances shorter than the Fresnel parameter S=D²/(4λ).

In this manner, microprocessor 445 is able to calculate a phase mismatch between a signal at port ‘C’ 432 and the signal at port ‘D’ 436 and thereafter determine a phase mismatch compensation to be applied to the variable phase shifter (‘α’) 420 via accurate control of the operation of the motor 447. Advantageously, the variable phase shifter 420 output can be calibrated in a manner that facilitates a closed loop control of phase shifts. In addition, by applying a phase adjustment on one or more of the antenna feed paths, it is possible for the microprocessor 445 to optimise polarization at the output of the antenna to include at least one from a group consisting of: LP, CP and elliptical polarization.

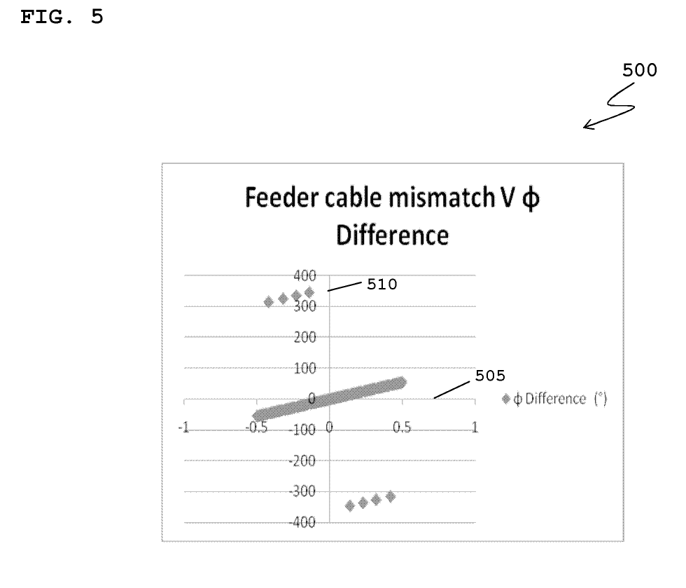

Referring now to FIG. 5, a graphical example 500 of feeder cable mismatch in metres 505 vs. phase difference 510 in degrees is illustrated. In the example of FIG. 5, two carrier frequencies are used to determine a phase mismatch across a range of frequencies, for example a first frequency may be selected at a lower end of the antenna array frequency range and a second frequency may be selected at a higher end of the antenna array frequency range. Generally, in compensating for phase mismatches, phase differences up to 360 degrees only are considered. However, in some examples, when phase mismatches are multiple (360 degree) cycles apart, an interpolation algorithm may be employed to compensate for ‘cycle’ mismatches when changing frequency of operation using two (or more) frequencies in the installation calibration program. In one example, a substantially linear interpolation between the results of the two carrier frequency results may be applied to determine a phase mismatch at any particular frequency in the ranges. In one example, when interpolating phase-wraps may be tracked by identifying a slope change from one end of the frequency band to the other end of the frequency band. Depending on the frequency that is being transmitted, there may be a need to adjust the phase shifter to compensate for different phase shifts as a function of frequency. In this manner, adjustment of the variable phase shifter 420 may be performed to compensate for phase mismatch in the antenna feeds as a function of frequency and/or taking account of any number of cycle mismatches.

Outliers on the example plot 500 of FIG. 5 are at points where the phase wraps around at one of the calibration test frequencies. As illustrated, for the term

$$j \cdot sin ( ( α + θ ) \cdot \frac{f 1}{2 π} )$$

of Eqn. [7] to be substantially zero, then there is a frequency dependency on the equation that requires the ‘α’ term to change as a function of transmit frequency. For the cited example as shown in FIG. 5 there is a 1.096° change in slope across the transmit band of UMTS™ Band I, for every 1 cm mismatch in cable length.

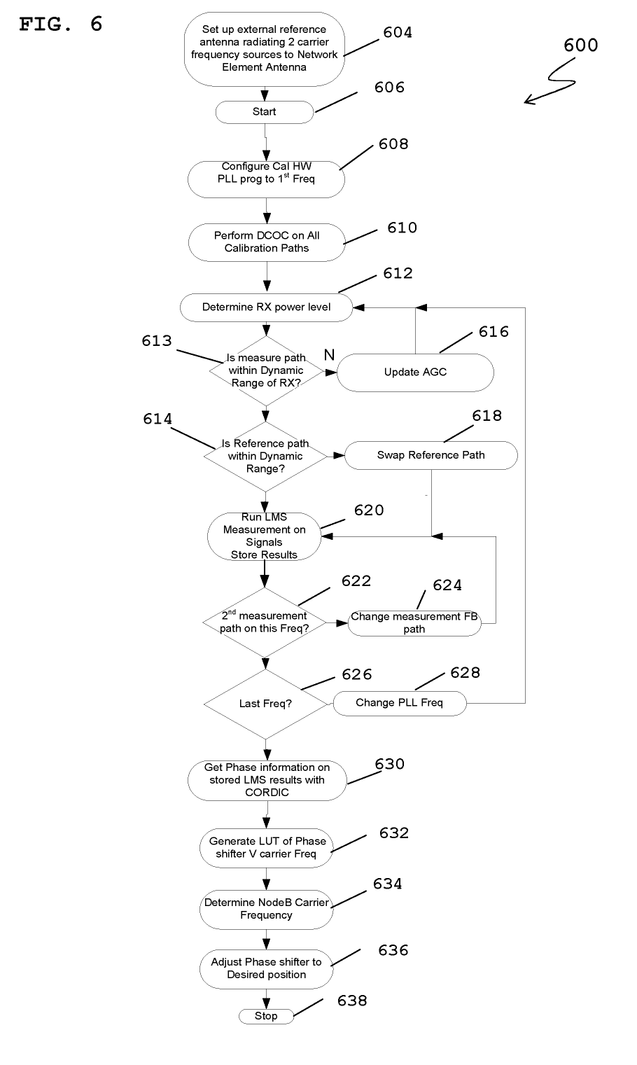

In some examples, the polarization control device 360 has a number of operational modes, as illustrated below with respect to FIG. 6. A first operational mode may involve an installation calibration mode, which may be used to determine whether any cable feed phase mismatch exists, which may include running a calibration algorithm to determine a phase of both incoming signals and thereby determine any cable feed mismatch between the two paths/signals.

A second operational mode may involve a phase adjustment operational mode, which may employ performing a phase adjustment of the variable phase shifter to a correct position, using phase adjustment values determined during the installation calibration mode. The second operational mode may involve motor control, to precisely control a motor stop position to effect a desired phase change and thereby a desired phase response of the variable phase shifter 420.

A third operational mode may be an in-service calibration mode. In this third operational mode the polarization control device 360 may be configured to determine an accuracy of the variable phase shifter 420 in the polarization control device 360 as well as a determination of the phase shift results to be used during the (second) phase adjustment mode.

Once calibration is complete, the polarization control device 360 may enter a static ‘standby mode’ allowing accurate CP signals to be generated by the polarization control device 360. This static ‘standby mode’ is a low power mode of operation where the device is still powered. In one example, all circuits may be switched off in static ‘standby mode, other than those for monitoring communication interrupts over the AISG™ interface.

Referring now to FIG. 6, an example of a flowchart 600 for calibrating and control of the polarization control device is illustrated. The flowchart 600 commences in step 604 whereby the external stimuli are enabled, for example a two reference carrier signal is radiated to the network element antenna under calibration of a known polarization. The polarization control device 360 is initiated to start installation calibration in step 606. In response thereto, a processor (such as microprocessor 445 in the polarization control device 360 of FIG. 4) configures hardware for calibration, as shown in step 608. In one example, such configuration may include enabling receiver circuits and enabling clock signals. In another example, the phase lock loop program setting of the receiver frequency in the processing unit 490 of FIG. 4 may also be set to a first (test) frequency.

Once the installation calibration routine has completed in step 608, the process then move to step 610, whereby DC offsets may be removed, for example removed from digitized signals output from the ADC devices 486 of FIG. 4. In this example, such a process is desirable as DC components that manifest due to analog signal processing chain imperfections could be larger than the wanted signal, thereby adversely affecting the ability to measure received signal power and, thus, adversely affecting the ability for mismatch detection algorithm to converge. One known method of DCOC (Direct Current offset compensation) is to perform a process whereby a received signal is averaged over a period of time and a DC offset value is estimated. Such an estimated value can be subtracted from a subsequent signal that is processed. In one example, such a subtraction function may be performed for all receiver ADC 486 outputs in the FPGA 448 of FIG. 4.

Once the DC offsets have been removed in step 610, the process progress to step 612 which measures the received signal power is measured by the respective receiver, for example receiver connected to directional coupler ports 430 or 434 of FIG. 4, as shown in step 612. A determination is then made as to whether (or not) the received signal is within the dynamic range acceptable for running of the measurement algorithm, as illustrated in step 613, as the ADC has finite dynamic range and the gain of such receiver blocks needs to be adjusted to best fit the dynamic range window. For example, it is desirable to have the received signal within the dynamic range of the receiver so that the received signal has sufficient signal-to-noise ratio, or that the receiver is not saturated, which could adversely affect the measurement algorithm.

If the receiver is not within a desirable range in step 613, the process moves to step 616 where the gain of the receiver is increased or decreased dependent upon the status of the measurement in step 613 and the process loops back to step 612. This process repeats until a desirable signal range is achieved. In one example, the same Automatic Gain Control (AGC) loop result would set the gain on the receiver operably coupled to alternative directional couplers 408,404. If the receiver is within a desirable range in step 613, a determination is made as to whether (or not) the signal received at directional coupler port 404 has sufficient dynamic range to be used as a reference for the calibration measurement. If it is determined that the signal received at directional coupler port 404 has insufficient dynamic range to be used as a reference for the calibration measurement, in step 614, the second path that passes through the alternative directional coupler port 408 is selected and used as the reference path. Either or both paths will have sufficient power dependent upon the unknown phase of the cable feed network.

Step 620 is invoked either following step 614 or 618. In step 620 a comparison between the signals received from the reference path (either from coupler 404 connected to port ‘A’ 402 or from coupler 408 connected to port ‘B’ 406 in FIG. 4) is made to signals received through coupler 430 connected to port ‘C’ 432, as selected through switch 440 of FIG. 4. Since the signals are down-converted in cartesian In-phase (I) and Quadrature (Q)) format, then, in one example, a comparison is best realizable with signals in this format. For example, algorithms such as a Least Mean Square (LMS) adaptive filter may be used to determine the ‘I’ and ‘Q’ differences between paths, a result of which may then be stored.

Once the comparison of step 622 is completed, a determination is made as to whether (or not) a second measurement is to be made at this RF carrier frequency. If a second (or further) measurement at this RF carrier frequency is to be made in step 622, the processor re-configures the receiver path routing, for example by re-configuring the switch selection of switch 440 to select signals coupled from directional coupler 434 connected to port ‘D’ 436 of FIG. 4. A second measurement result is then taken that compares the signals received from the reference path either from directional coupler 404 connected to port ‘A’ 402 or from directional coupler 408 connected to port ‘B’ 406 to signals received through coupler 434 connected to port ‘D’ 436 selected through switch 440 of FIG. 4. This result is stored.

If a second (or further) measurement at this RF carrier frequency is not to be made in step 622, a determination as to whether (or not) the last carrier frequency measurements have been completed is made in step 626. If it is determined in step 626 that the last carrier frequency measurements have not been completed, the phase lock loop programming sets the receiver frequency in processing unit 490 to a least one other receive frequency in step 628. The process then loops back to step 612 and the process repeats for the at least one other receive frequency, as outlined heretofore. If it is determined in step 626 that the last carrier frequency measurements have been completed, the two stored measurement results for the first carrier frequency are subtracted in step 630 to determine the ‘I’ difference and ‘Q’ difference of signals between port ‘C’ 432 and port ‘D’ 436, as measured through the respective couplers 430, 434. Since this result is in cartesian format there is a need to convert to a phase result, for example by the use of an arctan function of the CORDIC algorithm. The process is repeated using the two stored measurement results the subsequent at least one second carrier frequency, which are also subtracted to determine the ‘I’ difference and ‘Q’ difference of signals between port ‘C’ 432 and port ‘D’ 436, as measured through the respective couplers 430, 434, with the subsequent translation into a phase result ensured using the CORDIC arctan function.

In some examples, measured results may have offsets applied, so as to overcome any process mismatches that may occur in the manufacture of, for example, the couplers 434, 430, or the switch 440. In some examples, such offset parameters may be stored as part of manufacturing process of the polarization control device 360.

Once the CORDIC arctan function results have been obtained in step 630, a Look Up Table (LUT) of RF carrier frequency versus phase shifter setting is generated in step 632. In one example, the generation of the LUT may involve determining a phase offset required per carrier frequency. For step 630, the ideal phase response, in a perfectly matched cable feed network system where a VP signal for a known polarization device is used in the calibration process, would result in a 180° difference between port ‘C’ 432 and port ‘D’ 436 of the polarization control device 360. The difference between this idealised phase and that determined in step 630 may then be calculated. A substantially linear equation may then be used to map desired phase error versus frequency for the desired radiated polarization.

In one example, the motor position actuator-to-phase shifter 420 response is known apriori, for example as a consequence of either the design or manufacturing process. In step 634, a determination of RF carrier frequency versus motor position response is performed. Such a determination enables the processor to map motor position versus carrier frequency. In one example, this result can be stored in LUT format or as an equation format that can be processed by the microprocessor in step 634.

It will be appreciated by skilled artisans that not each discrete frequency phase shifter setting be stored or calculated. For example, the result could quantize a phase shifter setting per band or on a sub-band basis. Furthermore, results may be stored in non-volatile memory to preserve results in a case of an intermittent power failure.

In one example, the determination of Node B carrier frequency of a desired polarization may be made in a number of ways, which include, for example, programming over the AISG™ interface of information pertaining to the channel frequency, or by means of a frequency channel scan result to determine powers above a threshold level in order to detect transmit frequencies of the Node B as detected through the directional coupler (feedback) ports 430, 434, 408 or 404. Once a desired frequency is known in step 634 the processor may trigger a movement of the variable phase shifter 420 of FIG. 4, if desired and in step 636, based on the calculation determined in step 632.

In some example embodiments, control of the variable phase shifter 420 may not be precise enough to result to deliver a best possible setting of the desired polarization control, which may impact the accuracy of the phase setting. Examples of the lack of preciseness may result from tolerances of motor position, mechanical hysteresis in a case of solid state phase shifters, voltage or temperature parameter variations.

In one example, the signal processing in the FPGA 448 and/or microprocessor 445 may determine from the received signals an idealised reference output to be used, as can be observed at port ‘D’ 436 and port ‘C’ 432. Such a received signal, as sensed on port ‘D’ 436 and port ‘C’ 432 may be compared with the idealised reference and may be used to make a refinement/re-positioning of the phase shifter setting ‘a’, in order to generate a signal that is substantially close to the ideal reference.

Once the variable phase shifter setting has been completed in step 636, the polarization control device 360 control and calibration aspects of the device may be disabled. In some examples, steps 634 and 636 may be repeated at any time after installation, as and when there is a need. For example, such a need could be due to a change of operating/carrier frequency of the Node B, or to effect a change of a phase response especially if a solid state phase shifter solution is employed.

The Calibration algorithm sequentially determines the phase of the signal for at least two frequencies detected on both ports ‘D’ and ‘C’. A difference in phase between ports ‘C’ and ‘D’ is determined for at least two discrete frequencies under test, as a single frequency test does not allow full determination of the ‘Θ’ term, especially if it is used to extrapolate across a broad frequency range. The change in phase difference between both frequencies under test measurements allows a determination of the ‘Θ’ term.

In one example, any mismatch within one or more of the 4-port directional couplers that is/are used in the polarization control device may be stored in memory when manufacturing or installing the polarization control device and can be added as an offset to the result to ensure that internal calibration of the 4-port directional coupler(s) is taken into account.

In one example, it is assumed that running the above calibration program and effecting any adjustments identified by the program compensates for any phase mismatch within the polarization control device. However, in other examples, it is envisaged that further measurements at the output of the polarization control device may be made to confirm that the correct phase was applied, and if not the calibration program re-run. The LUT or stored values would be updated as a result of such steps.

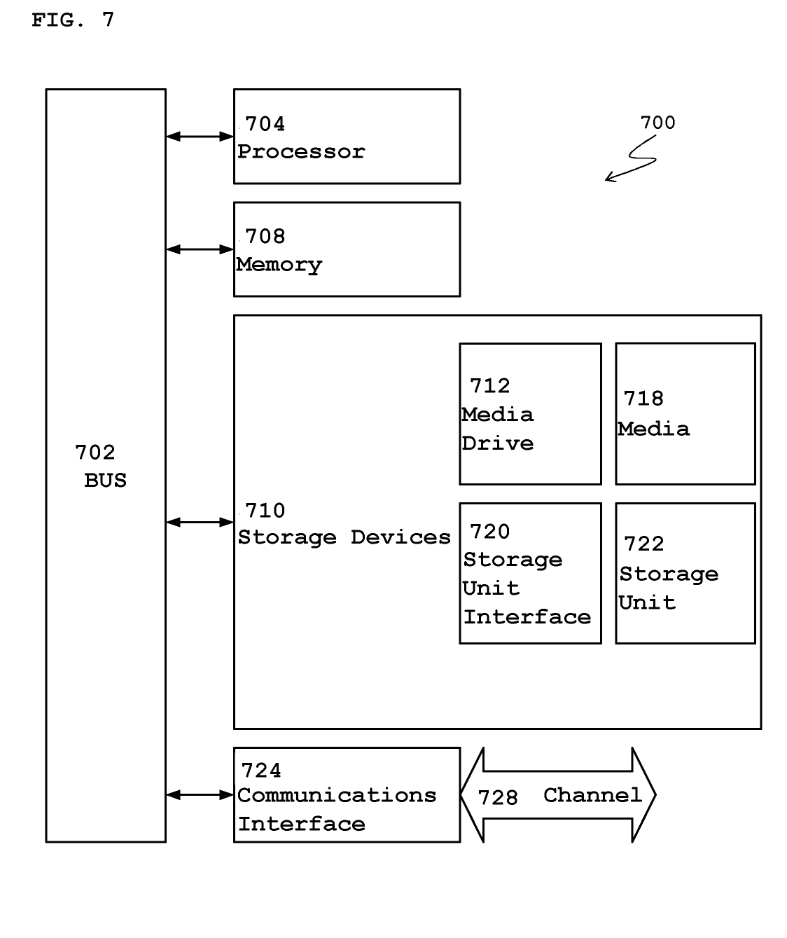

Referring now to FIG. 7, there is illustrated a typical computing system 700 that may be employed to implement signal processing functionality in embodiments of the invention. Computing systems of this type may be used in access points and wireless communication units. Those skilled in the relevant art will also recognize how to implement the invention using other computer systems or architectures. Computing system 700 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1000 can include one or more processors, such as a processor 704. Processor 704 can be implemented using a general or special-purpose processing engine such as, for example, a microprocessor, microcontroller or other control logic. In this example, processor 704 is connected to a bus 702 or other communications medium.

Computing system 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 718 may include, for example, a hard disk, floppy disk, magnetic tape, optical disk, CD or DVD, or other fixed or removable medium that is read by and written to by media drive 712. As these examples illustrate, the storage media 718 may include a computer-readable storage medium having particular computer software or data stored therein.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other NIC card), a communications port (such as for example, a universal serial bus (USB) port), a PCMCIA slot and card, etc. Software and data transferred via communications interface 724 are in the form of signals which can be electronic, electromagnetic, and optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’, ‘computer-readable medium’ and the like may be used generally to refer to media such as, for example, memory 708, storage device 718, or storage unit 722. These and other forms of computer-readable media may store one or more instructions for use by processor 704, to cause the processor to perform specified operations. Such instructions, generally referred to as ‘computer program code’ (which may be grouped in the form of computer programs or other groupings), when executed, enable the computing system 700 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, removable storage drive 722, drive 712 or communications interface 724. The control logic (in this example, software instructions or computer program code), when executed by the processor 704, causes the processor 704 to perform the functions of the invention as described herein.

It will be appreciated that, for clarity purposes, the above description has described embodiments of the invention with reference to different functional units and processors. However, it will be apparent that any suitable distribution of functionality between different functional units or processors, for example with respect to the radio frequency domain and the baseband processing circuits of the polarization control device 360, may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to “a”, “an”, “first”, “second”, etc., do not preclude a plurality.

1. A polarization control device for compensating phase mismatch, wherein the polarization control device is operably coupleable via at least two radio frequency (RF) feed paths to an antenna arrangement that comprises at least two orthogonally polarized antenna elements, wherein the polarization control device comprises or is operably coupleable to at least one variable phase shifter located on at least one RF feed path; wherein the polarization control device (360) is characterised by: processing module configured to:
receive and process a coupled amount of at least one first RF signal;
determine a phase mismatch between the at least two RF feed paths to the antenna arrangement of the processed at least one first RF signal; and
adjust a phase shift to be applied by the at least one variable phase shifter for phase shifting at least one second RF signal applied to the at least one feed path passing there through to the at least two orthogonally polarized antenna elements, based on the determined phase mismatch and a desired polarization of the at least one second RF signal to be radiated from the antenna arrangement (219).

2. The polarization control device of claim 1, further comprising at least one input port and at least one output port and comprising or operably coupleable to a hybrid coupler operably coupled to the variable phase shifter for routing RF signals from and to the at least one input port and the at least one output port via the variable phase shifter.

3. The polarization control device of claim 2, wherein the processing module comprises at least one processor operably coupled to a plurality of receivers for respectively receiving RF signals applied to one or more of the at least one input port and the at least one output port.

4. The polarization control device of claim 2, further comprising a bypass path coupled to the hybrid coupler, such that the processing module is capable of routing signals to bypass the hybrid coupler.

5. The polarization control device of claim 1, wherein the at least one variable phase shifter is operably couplable to a stepper motor such that the processing module configures the stepper motor to adjust a phase shift (‘α’) to be applied by the at least one variable phase shifter to RF signals passing there through.

6. The polarization control device of claim 5, wherein the variable phase shifter is located on each of the at least two RF feed paths such that the processing module adjusts a phase shift (‘α’) to be applied by the at least one variable phase shifter to RF signals passing through either or both of the at least two RF feed paths.

7. The polarization control device of claim 1, wherein at least two frequency separated RF signals are routed via the at least two RF feed paths from the antenna arrangement, such that the processing module is arranged to determine the phase mismatch between the at least two RF feed paths to the antenna arrangement for each of the respective frequency separated RF signals.

8. The polarization control device of claim 7, wherein the processing module (490) is configured to adjust the phase shift to be applied to the variable phase shifter as a function of frequency.

9. The polarization control device of claim 7, wherein the processing module is configured to adjust the phase shift to be applied to the variable phase shifter based on a function of phase mismatch between the at least two RF feed paths to the antenna arrangement where the phase mismatch is more than one 360° cycle of phase difference.

10. The polarization control device of claim 1, wherein the at least two RF feed paths comprise a co-polarization feed 335 and a cross polarization feed 340 between the polarization control device and the antenna arrangement.

11. The polarization control device of claim 1, wherein the at least one first RF signal is routed via the at least two RF feed paths from an antenna arrangement, such that the processing module is arranged to determine a phase mismatch between the at least two RF feed paths to the antenna arrangement.

12. The polarization control device of claim 11, wherein the first RF signal is sourced from a signal source coupled to a radiative source placed in a far-field of known polarization.

13. The polarization control device of claim 11, wherein the first RF signal is sourced from a signal source coupled to a radiative source placed in a near-field of known polarization.

14. The polarization control device of claim 1, wherein a desired polarization type of the RF signals comprises at least one from a group consisting of:
(i) a cross polarization type;
(ii) a circularly polarization (CP) type, such as left hand CP, right hand CP;
(iii) a linear polarization (LP) type; or;
(iv) an elliptical polarization type.

15. An integrated circuit for a polarization control device for compensating phase mismatch, wherein the polarization control device is operably couplable via at least two radio frequency (RF) feed paths to an antenna arrangement that comprises at least two orthogonally polarized antenna elements, the polarization control device operably coupleable to at least one variable phase shifter located on at least one RF feed path; wherein the integrated circuit comprises:
processing module arranged to:
receive and process a coupled amount of at least one first RF signal;
determine a phase mismatch between the at least two RF feed paths to the antenna arrangement of the processed at least one first RF signal; and
adjust a phase shift to be applied by the at least one variable phase shifter for phase shifting at least one second RF signal applied to the at least one feed path passing there through to the at least two orthogonally polarized antenna elements, based on the determined phase mismatch and a desired polarization of the at least one second RF signal to be radiated from the antenna arrangement.

16. A method for compensating phase mismatch between a polarization control device (360) and an antenna arrangement couplable via at least two radio frequency (RF) feed paths, the method comprising:
receiving and processing at least one first RF signal;
determining a phase mismatch between the at least two RF feed paths to the antenna arrangement of the processed at least one first RF signal; and
adjusting a phase shift to be applied to at least one second RF signal applied to the at least one feed path passing there through to the at least two orthogonally polarized antenna elements based on the determined phase mismatch and a desired polarization of the at least one second RF signal to be radiated from the antenna arrangement.

17. A method as in claim 16, further comprising the step of: utilizing a non-transitory computer readable medium having computer readable instructions thereon for execution by a processor compensating phase mismatch using a polarization control device, the executable program code operable for, when implemented in a control device, performing the method of claim 16.
